(19) United States
(12) Patent Application Publication
(10) Pub. No.: US 2020/0283577 A1
(43) Pub. Date: Sep. 10, 2020

(54) SOLVENT-FREE MELT POLYCONDENSATION PROCESS OF MAKING FURAN-BASED POLYAMIDES

(71) Applicant: DUPONT INDUSTRIAL BIOSCIENCES USA, LLC, Wilmington, DE (US)

(72) Inventors: Simona Percec, Philadelphia, PA (US); Stephen Neal Bair, Newark, DE (US)

(21) Appl. No.: 16/881,441

(22) Filed: May 22, 2020

Related U.S. Application Data
(63) Continuation of application No. 16/062,204, filed on Jun. 14, 2018, now abandoned.
(60) Provisional application No. 62/267,344, filed on Dec. 15, 2015.

(51) Int. Cl. C08G 69/40; C08G 69/30; C08G 69/28; B01J 27/10; B01J 27/18; B01J 27/232; B01J 31/02

(52) U.S. Cl. CPC C08G 69/40; C08G 69/30; C08G 69/28; B01J 31/0211; B01J 27/1806; B01J 27/232; B01J 27/10

(57) ABSTRACT

Disclosed herein are processes of making furan-based polyamides using solvent-free melt condensation of a diamine and an ester derivative of 2,5-furandicarboxylic acid with a C₂ to C₁₂ aliphatic diol or a polyol. The processes comprise a) forming a reaction mixture by mixing one or more diamines, a diester comprising an ester derivative of 2,5-furandicarboxylic acid with a C₂ to C₁₂ aliphatic diol or a polyol, and a catalyst, such that the diamine is present in an excess amount of at least 1 mol % with respect to the diester amount; and b) melt polycondensing the reaction mixture in the absence of a solvent at a temperature in the range of 60° C. to a maximum temperature of 250° C. under an inert atmosphere, while removing alkyl alcohol to form a furan-based polyamide, wherein the one or more diamines comprises an aliphatic diamine, an aromatic diamine, or an alkylaromatic diamine.

### CROSS REFERENCE TO RELATED APPLICATIONS

This application is a Continuation of U.S. Non Provisional application Ser. No. 16/062,204 filed on Jun. 14, 2018 which is a 371 of International Application No. PCT/US2016/66761 filed on Dec. 15, 2016 which claims the benefit of priority of United States Provisional Application No. 62/267,344 filed on Dec. 15, 2015, the entire disclosure of which is herein incorporated by reference.

### FIELD OF THE DISCLOSURE

The present disclosure relates in general to furan-based polyamides and to a solvent-free melt polycondensation process of making furan-based polyamides of high molecular weight.

### BACKGROUND

Polyamides, such as nylon are commercially synthesized by a melt polycondensation process. Though, synthesis of furan-derived polyamides has been known for more than 50 years, there are no commercially viable routes that produce polyamides of sufficiently high molecular weight to allow for good mechanical/thermal properties or barrier features. A comparative study by Hopff and Krieger in Helvetica Chimica Acta, 44, 4, 1058-1063, 1961 involving 2,5-furan dicarboxylic acid (FDCA) and adipic acid (AA) pointed out important differences in the intrinsic characteristics of the monomers that inherently play a role in their polycondensation reaction with hexamethylene diamine (HMD). One issue is the decomposition temperature (T_{d}) of FDCA, which is lower than that of other diacids such as adipic acid (AA) used in the polyamide synthesis. Another issue is that the melting temperature (Tₘ) of the salts of FDCA with diamines, such as of FDCA:HMD salt, is 33° C. higher than its T_{d}. In contrast, the Tₘ of AA:HMD salt is only 16° C. higher than its T_{d}. The relatively large difference between the melting and decomposition temperature of FDCA:HMD salt imposes severe limitations for the conventional melt polycondensation process due to the loss of the stoichiometry associated with salt decomposition. In addition, decarboxylation reactions could occur at high temperatures, transforming the diacids into monoacids and retarding the development of polymers with high molecular weight.

Hence, there is a need for a new melt polycondensation process for making furan-based polyamides and copolyamides with high molecular weight.

### SUMMARY

In a first embodiment, there is a process comprising:
a) forming a reaction mixture by mixing one or more diamines, a diester comprising an ester derivative of 2,5-furandicarboxylic acid with a C₂ to C₁₂ aliphatic diol or a polyol, and a catalyst, such that the diamine is present in an excess amount of at least 1 mol % with respect to the diester amount; and
b) melt polycondensing the reaction mixture in the absence of a solvent at a temperature in the range of 60° C. to a maximum temperature of 250° C. under an inert atmosphere, while removing alkyl alcohol to form a furan-based polyamide, wherein the one or more diamines comprises an aliphatic diamine, an aromatic diamine, or an alkylaromatic diamine.

In a second embodiment of the process, the catalyst is selected from hypophosphorus acid, potassium hypophosphite, sodium hypophosphite monohydrate, phosphoric acid, 4-chlorobutyl dihydroxyzinc, n-butyltin chloride dihydroxide, titanium(IV) isopropoxide, zinc acetate, 1-hydroxybenzotriazole, and sodium carbonate.

In a third embodiment of the process, the diamine is present in the reaction mixture in an excess amount of at least 5 mol % with respect to the diester amount.

In a fourth embodiment of the process, the step of melt polycondensing the reaction mixture in the absence of a solvent at a temperature in the range of 60° C. to a maximum temperature of 250° C. under an inert atmosphere further comprises:
i) first heating the reaction mixture to a temperature in the range of 60° C. to 100° C. for 30-60 minutes
ii) ramping the temperature of the reaction mixture from 100° C. to a maximum temperature of 250° C. for an amount of time in the range of 30 to 240 minutes;
iii) holding the maximum temperature of the reaction mixture constant for an amount of time in the range of 40 to 800 minutes.

In a fifth embodiment, the process further comprises adding at least one of a heat stabilizer or an anti-foaming agent to the reaction mixture.

In a sixth embodiment, the process further comprises solid state polymerizing the furan-based polyamide at a temperature between the glass transition temperature and melting point of the polyamide.

In a seventh embodiment, the process further comprises solid state polymerizing the furan-based polyamide at a temperature in the range of 140° C. to 250° C.

In an eighth embodiment of the process, the aliphatic diamine comprises one or more of hexamethylenediamine, 1,4-diaminobutane, 1,5-diaminopentane, (6-aminohexyl)carbamic acid, 1,2-diaminoethane, 1,12-diaminododecane, 1,3-diaminopropane, 1,5-diamino-2-methylpentane, 1,3-bis(aminomethyl)cyclohexane, 1,4-bis(aminomethyl)cyclohexane, mixtures of 1,3- and 1,4-bis(aminomethyl)cyclohexane, norbornanediamine, (2,5 (2,6) bis(aminomethyl)bicycle(2,2,1)heptane), 1,2-diaminocyclohexane, 1,4- or 1,3-diaminocyclohexane, isophoronediamine, and isomeric mixtures of bis(4-aminocyclohexyl)methane.

In a ninth embodiment of the process, the aromatic diamine comprises one or more of 1,3-diaminobenzene, phenylenediamine, 4,4′-diaminodiphenyl ether, 4,4′-diaminodiphenyl sulfone, 1,5-diaminonaphthalene, sulfonic-p-phenylene-diamine, 2,6-diamonopyridine, naphthidine, benzidine, and o-tolidine.

In a tenth embodiment of the process, the alkylaromatic diamine comprises one or more of m-xylylene diamine, 1,3-bis(aminomethyl)benzene, p-xylylene diamine, and 2,5-bis-aminoethyl-p-xylene.

In an eleventh embodiment of the process, at least one of the one or more diamines is hexamethylenediamine.

In a twelfth embodiment of the process, at least one of the one or more diamines is trimethylenediamine.

In a thirteenth embodiment of the process, at least one of the one or more diamines is m-xylylene diamine.

In a fourteenth embodiment of the process, the furan-based polyamide comprises the following repeat unit:

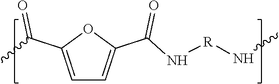

wherein R is selected from an alkyl, aromatic, and alkylaromatic group.

### DETAILED DESCRIPTION

The disclosures of all patent and non-patent literature cited herein are hereby incorporated by reference in their entireties.

The terms “comprises,” “comprising,” “includes,” “including,” “has,” “having” or any other variation thereof, as used herein are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). The phrase “one or more” is intended to cover a non-exclusive inclusion. For example, one or more of A, B, and C implies any one of the following: A alone, B alone, C alone, a combination of A and B, a combination of B and C, a combination of A and C, or a combination of A, B, and C.

Also, use of “a” or “an” are employed to describe elements and described herein. This is done merely for convenience and to give a general sense of the scope of the invention. This description should be read to include one or at least one and the singular also includes the plural unless it is obvious that it is meant otherwise.

The term “biologically-derived” is used interchangeably with “biobased” or “bio-derived” and refers to chemical compounds including monomers and polymers that are obtained, in whole or in any part, from any renewable resources including but not limited to plant, animal, marine materials or forestry materials. The “biobased content” of any such compound shall be understood as the percentage of a compound's carbon content determined to have been obtained or derived from such renewable resources.

The term “dicarboxylic acid” is used interchangeably with “diacid”. The term “furandicarboxylic acid” as used herein is used interchangeably with furandicarboxylic acid; 2,5-furandicarboxylic acid; 2,4-furandicarboxylic acid; 3,4-furandicarboxylic acid; and 2,3-furandicarboxylic acid. As used herein, the term 2,5-furandicarboxylic acid (FDCA) is used herein interchangeable with “furan-2,5-dicarboxylic acid”, which is also known as dehydromucic acid and is an oxidized furan derivative, as shown below:

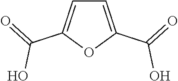 [SMILES: O=C(O)c1ccc(C(=O)O)o1]

The term “furan-2,5-dicarboxylic acid (FDCA) or a functional equivalent thereof” as used herein refers to any suitable isomer of furandicarboxylic acid or derivative thereof such as, 2,5-furandicarboxylic acid; 2,4-furandicarboxylic acid; 3,4-furandicarboxylic acid; 2,3-furandicarboxylic acid or their derivatives.

In a derivative of 2,5-furan dicarboxylic acid, the hydrogens at the 3 and/or 4 position on the furan ring can, if desired, be replaced, independently of each other, with —CH₃, —C₂H₅, or a C₃ to C₂₅ straight-chain, branched or cyclic alkane group, optionally containing one to three heteroatoms selected from the group consisting of O, N, Si and S, and also optionally substituted with at least one member selected from the group consisting of —Cl, —Br, —F, —I, —OH, —NH₂ and —SH. A derivative of 2,5-furan dicarboxylic acid can also be prepared by substitution of an ester or halide at the location of one or both of the acid moieties.

As used herein, “alkylaromatic” refers to an aromatic group, such as a phenyl group, which contains at least one organic substituent.

In describing certain polymers it should be understood that sometimes applicants are referring to the polymers by the monomers used to produce them, or to the amounts of the monomers used to produce the polymers. While such a description may not include the specific nomenclature used to describe the final polymer or may not contain product-by-process terminology, any such reference to monomers and amounts should be interpreted to mean that the polymer comprises copolymerized units of those monomers or that amount of the monomers, and the corresponding polymers and compositions thereof.

The term “homopolymer” or “polyamide” in the context of polyamides means a polymer polymerized from two monomers (e.g., one type of diamine and one type of diacid (or alkyl ester of diacid)), or more precisely, a polymer containing one repeat unit. The term “copolymer” or “copolyamide” means a polyamide polymer polymerized from three or more monomers (such as more than one type of diamine and/or more than one type of diacid or alkyl ester of diacid), or more precisely, a polymer containing two or more repeat units, and thereby includes terpolymers or even higher order copolymers.

As used herein, the term “furan-based polyamide” refers to the polymers disclosed herein derived from a diamine and an ester derivative of 2,5-furandicarboxylic acid with a C₂ to C₁₂ aliphatic diol or a polyol.

Disclosed herein is a process of making a furan-based polyamide, the process comprising forming a reaction mixture by mixing one or more diamines, a diester comprising an ester derivative of 2,5-furandicarboxylic acid with a C₂ to C₁₂ aliphatic diol or a polyol, and a catalyst, such that the diamine is present in an excess amount of at least 1 mol % with respect to the diester, and melt polycondensing the reaction mixture in the absence of a solvent at a temperature in the range of 60° C. to a maximum temperature of 250° C. under an inert atmosphere, while removing alkyl alcohol to form a polyamide.

The reaction mixture must comprise non-stoichiometric amounts of diamine and diester, such that the diamine is present in an excess amount of at least about 1 mol %, or at least about 1.5 mol %, or at least about 3 mol %, or at least about 5 mol %, or at least about 7 mol %, or at least about mol %, or at least about 15 mol %, or at least about 20 mol %, or at least about 25 mol % with respect to the diester amount. In other embodiments, the diamine monomer is present in an excess amount of as low as 1 mol %, 1.5 mol %, 2.5 mol % or 5 mol %, or 7 mol % and as high as 3 mol %, 5 mol %, 7 mol %, 10 mol %, 15 mol %, 20 mol %, 25 mol %, or within any range defined between any pair of the foregoing values with respect to the diester amount.

Any suitable diamine monomer (H₂N—R—NH₂) can be used, where R (or in some embodiments R¹ or R²) is an aliphatic, aromatic, or alkylaromatic group.

Any suitable aliphatic diamine comonomer (H₂N—R—NH₂), such as those with 2 to 12 number of carbon atoms in the main chain can be used. Suitable aliphatic diamines include, but are not limited to, hexamethylenediamine (also known as 1,6-diaminohexane), 1,5-diaminopentane, 1,4-diaminobutane, 1,3-diaminopropane, 1,2-diaminoethane, (6-aminohexyl) carbamic acid, 1,12-diaminododecane, 1,5-diamino-2-methylpentane, 1,3-bis(aminomethyl)cyclohexane, 1,4-bis(aminomethyl)cyclohexane, mixtures of 1,3- and 1,4-bis(aminomethyl)cyclohexane, norbornanediamine (2,5 (2,6) bis(aminomethyl)bicycle(2,2,1)heptane), 1,2-diaminocyclohexane, 1,4- or 1,3-diaminocyclohexane, isophoronediamine, and isomeric mixtures of bis(4-aminocyclohexyl)methane.

Any suitable aromatic diamine comonomer (H₂N—R—NH₂), such as those with ring sizes between 6 and 10 can be used. Suitable aromatic diamines include, but are not limited to phenylenediamine,4,4′-diaminodiphenyl ether,4,4′-diaminodiphenyl sulfone,1,5-diaminonaphthalene, sulfonic-p-phenylene-diamine, 2,6-diamonopyridine, naphthidine, benzidine, o-tolidine, and mixtures thereof.

Suitable alkylaromatic diamines include, but are not limited to, 1,3-bis(aminomethyl)benzene, m-xylylene diamine, p-xylylene diamine, 2,5-bis-aminoethyl-p-xylene, and derivatives and mixtures thereof.

In an embodiment, the one or more diamine monomers comprises at least one of 1,3-propane diamine, hexamethylenediamine, and m-xylylene diamine.

In an embodiment, at least one of the one or more diamine monomers is hexamethylenediamine. In another embodiment, at least one of the one or more diamine monomers is trimethylenediamine. In yet another embodiment, at least one of the one or more diamine monomers is m-xylylene diamine. In another embodiment, the one or more diamine monomers comprises trimethylenediamine and m-xylylene diamine.

The furan-based polyamide obtained via melt-polycondensing one or more diamines and an alkyl ester of furan dicarboxylic acid, as disclosed hereinabove comprises the following repeat unit (1):

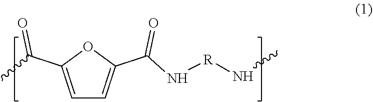

wherein R (═R¹ and R²) is independently selected from an alkyl, aromatic and alkylaromatic group, as disclosed herein above.

In an embodiment R¹ and R² are same, i.e. R═R¹═R². In another embodiment, R¹ and R² are different, i.e. R═R¹ and also R═R² and R¹≠R². In another embodiment, R═R¹, R² and R³.

In an embodiment, the process of melt polycondensing a reaction mixture comprising one or more diamine monomers and an ester derivative of 2,5-furandicarboxylic acid with a C₂ to C₁₂ aliphatic diol or a polyol further comprises adding an additional ester derivative of a diacid as another diacid monomer.

The furan-based polyamide obtained via melt-polycondensing one or more diamines and two or more alkyl esters of diacids comprising furan dicarboxylic acid, as disclosed hereinabove comprises the following repeat units (1) and (2):

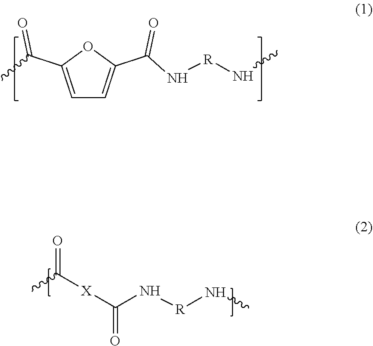

wherein X, R (═R¹ and R²) are independently selected from an alkyl, aromatic and alkylaromatic group.

In an embodiment R¹ and R² are same, i.e. R═R¹═R². In another embodiment, R¹ and R² are different, i.e. R═R¹ and also R═R² and R¹≠R². In another embodiment, R═R¹, R² and R³.

Any suitable ester of a dicarboxylic acid (HOOCXCOOH) can be used, where X═R¹ and R² is a linear aliphatic, cycloaliphatic, aromatic, or alkylaromatic group.

Suitable esters of dicarboxylic acids described supra include, but are not limited to, methyl, ethyl, isopropyl, n-propyl, n-butyl, isobutyl, sec-butyl or tert-butyl esters, more preferably the methyl, ethyl or n-butyl esters. In an embodiment, diacids and their esters are obtained from renewable sources, such as azelaic acid, sebacic acid, succinic acid, and mixtures thereof.

The aliphatic diacid (HOOCXCOOH) may include from 2 to 18 carbon atoms in the main chain. Suitable aliphatic diacids include, but are not limited to, adipic acid, azelic acid, sebacic acid, dodecanoic acid, fumaric acid, maleic acid, succinic acid, hexahydrophthalic acids, cis- and trans-1,4-cyclohexanedicarboxylic acid, cis- and trans-1,3-cyclohexanedicarboxylic acid, cis- and trans-1,2-cyclohexanedicarboxylic acid, tetrahydrophthalic acid, trans-1,2,3,6-tetrahydrophthalic acid, dihydrodicyclopentadienedicarboxylic acid, and mixtures thereof. In an embodiment, the aliphatic diacid comprises a mixture of cis- and trans-cyclohexane dicarboxylic acid.

An aromatic diacid (HOOCXCOOH) may include a single ring (e.g., phenyl), multiple rings (e.g., biphenyl), or multiple condensed rings in which at least one is aromatic, (e.g., 1,2,3,4-tetrahydronaphthyl, naphthyl, anthryl, or phenanthryl), which is optionally mono-, di-, or trisubstituted with, e.g., halogen, lower alkyl, lower alkoxy, lower alkylthio, trifluoromethyl, lower acyloxy, aryl, heteroaryl, or hydroxy group(s). Suitable aromatic diacids include, but are not limited to, terephthalic acid, isophthalic acid, phthlalic acid, 2-(2-carboxyphenyl)benzoic acid, naphthalene dicarboxylic acid, biphenyl-4,4′-dicarboxylic acid, 1,3,5-benzenetricarboxylic acid, and mixtures thereof.

Suitable alkylaromatic diacids (HOOCXCOOH) include, but are not limited to, trimellitylimidoglycine, 1,3-bis(4-carboxyphenoxy)propane, and mixtures thereof.

Examples of various hydroxy acids (HOOCXCOOH) that can be included, in addition to the furan dicarboxylic acids, in the polymerization monomer makeup from which a copolymer can be made include glycolic acid, hydroxybutyric acid, hydroxycaproic acid, hydroxyvaleric acid, 7-hydroxyheptanoic acid, 8-hydroxycaproic acid, 9-hydroxynonanoic acid, or lactic acid; or those derived from pivalolactone, ε-caprolactone or L,L, D,D or D,L lactides.

The furan-based copolyamides (with two or more diamines or with two or more diacids) disclosed hereinabove are statistical copolyamides comprising the repeat units (1) and (2), as shown above, where the repeat unit (1) may be adjacent to itself or adjacent to the repeat unit (2) and similarly the repeat unit (2) may be adjacent to itself or adjacent to the repeat unit (1).

In the process of melt polycondensing the reaction mixture as disclosed herein above, any suitable polycondensation catalyst can be used. Exemplary catalyst include, but are not limited to, hypophosphorus acid, potassium hypophosphite, sodium hypophosphite monohydrate, phosphoric acid, 4-chlorobutyl dihydroxyzinc, n-butyltin chloride dihydroxide, titanium(IV) isopropoxide, zinc acetate, 1-hydroxybenzotriazole, and sodium carbonate.

In an embodiment, phosphorus-containing catalyst may be used. Suitable phosphorus-containing catalysts include phosphorous acid, phosphonic acid; alkyl and aryl substituted phosphonic acid; hypophosphorous acid; alkyl, aryl and alkylaromatic substituted phosphinic acid; and phosphoric acid; as well as the alkyl, aryl and alkylaromatic esters, metal salts, ammonium salts, and ammonium alkyl salts of these various phosphorus-containing acids. The esters are formed conventionally with the alkyl or aryl group replacing the hydrogen of an —OH group comprising the acid.

In one embodiment, sufficient amount of catalyst is added to the reaction mixture so that residual catalyst (determined analytically on phosphorous basis) exists after polymerization and polymer washing has been completed. Any suitable amount of catalyst can be added to the reaction mixture to provide phosphorus content in the reaction mixture to be at least about 1 ppm, or at least about 3 ppm, or at least about 5 ppm, or at least about 10 ppm, or at least about 20 ppm, or at least about 30 ppm, or at least about 50 ppm, or at least about 75 ppm, or at least about 100 ppm. In other embodiments, the amount of catalyst added to the reaction mixture to provide phosphorus content as low as 1 ppm, 3 ppm, 5 ppm or 10 ppm, and as high as 15 ppm, 20 ppm, 30 ppm, 50 ppm, 75 ppm, 100 ppm, or within any range defined between any pair of the foregoing values.

In the process of forming a reaction mixture by mixing one or more diamines, a diester comprising an ester derivative of 2,5-furandicarboxylic acid with a C₂ to C₁₂ aliphatic diol or a polyol, and a catalyst as disclosed herein above, the process may further comprise adding at least one of a heat stabilizer or an anti-foaming agent to the reaction mixture.

Any suitable heat stabilizer may be added to the reaction mixture, including, but not limited to, benzenepropanamide, N,N′-1,6-hexanediylbis[3,5-bis(1,1-dimethylethyl)-4-hydroxy; benzenepropanoic acid, 3,5-bis(1,1-dimethylethyl)-4-hydroxy-, 1,1′-[2,2-bis[[3-[3,5-bis(1,1-dimethylethyl)-4-hydroxyphenyl]-1-oxopro; copper salts; copper complexes; and hindered amines.

Any suitable antifoaming agent may be added to the reaction mixture, including, but not limited to, polyethylene glycols, polyethylene oxide, and silicone-based antifoaming agents.

In an embodiment, the process may further comprise adding additives commonly employed in the art such as process aids and property modifiers, such as, for example, glass fibers, antioxidants, plasticizers, UV light absorbers, antistatic agents, flame retardants, lubricants, colorants, nucleants, oxygen scavengers, fillers and heat stabilizers.

Suitable antioxidants include, but are not limited to, 2,5-di-tert-butylhydroquinone, 2,6-di-tert-butyl-p-cresol, 4,4′-thiobis-(6-tert-butylphenol), 2,2′-methylene-bis-(4-methyl-6-tert-butylphenol), octadecyl-3-(3′,5′-di-tert-butyl-4′-hydroxyphenyl) propionate, and 4,4′-thiobis-(6-tert-butylphenol).

Suitable UV light absorbers include, but are not limited to, ethylene-2-cyano-3,3′-diphenyl acrylate, 2-(2′-hydroxy-5′-methylphenyl)benzotriazole, 2-(2′-hydroxy-5′-methylphenyl)benzotriazole, 2-(2′-hydroxy-3′-tert-butyl-5′-methylphenyl)-5-chlorobenzotrazole, 2-hydroxy-4-methoxybenzophenone, 2,2′-dihydroxy-4-methoxybenzophenone, and 2-hydroxy-4-methoxybenzophenone.

Suitable plasticizers include, but are not limited to, phthalic acid esters such as dimethyl phthalate, diethyl phthalate, dioctyl phthalate, waxes, liquid paraffins, and phosphoric acid esters.

Suitable antistatic agents include, but are not limited to, pentaerythritol monostearate, sorbitan monopalmitate, sulfated polyolefins, polyethylene oxide, and carbon wax.

Suitable lubricants include, but are not limited to, ethylene bisstearoamide and butyl stearate.

Suitable colorants include, but are not limited to, carbon black, phthalocyanine, quinacridon, indoline, azo pigments, red oxide, etc.

Suitable fillers include, but are not limited to, glass fiber, asbestos, ballastonite, calcium silicate, talc, and montmorillonite.

Suitable nucleants to induce crystallization in the furan-based polyamide include, but are not limited to fine dispersed minerals like talc or modified days.

Suitable oxygen scavengers to improve the oxygen barrier include, but are not limited to, ferrous and non-ferrous salts and added catalysts.

In the process of melt polycondensing the reaction mixture in the absence of a solvent at a temperature in the range of 60° C. to a maximum temperature of 250° C. under an inert atmosphere, while removing alkyl alcohol to form a furan-polyamide, the process may further comprise first heating the reaction mixture to a temperature in the range of 60-100° C. for 30-60 minutes, followed by ramping the temperature of the reaction mixture from about 100° C. to a maximum temperature of 250° C. for an amount of time in the range of 30-240 minutes. Once the maximum temperature is reached, the temperature of the reaction mixture is held constant for an amount of time in the range of 40-800 minutes. Maximum temperature will depend on the nature of the diamine used. The heating is carried out under an inert atmosphere, such as nitrogen and a vacuum may be applied to assist in the removal of alkyl alcohol. Melt polycondensation of the present disclosure is carried out in the absence of a solvent, such as water and hence is referred to as the solvent-free melt polycondensation.

The process of making a furan-based polyamide further comprises solid-state polymerizing the furan-based polyamide obtained after melt polycondensation at a temperature between the glass transition temperature and melting point of the polymer. This temperature can reduce the possibility of heat-induced side reactions. Solid-state polymerization is also performed in the absence of solvents. The step of solid-state polymerization may further comprise purifying the polyamide obtained by melt polycondensation, followed by drying and pulverizing into a powder. The pulverized polyamide powder is then introduced into a suitable reactor, such as a packed bed reactor, a fluidized bed reactor, a fixed bed reactor, or a moving bed reactor. The polyamide is polymerized in a solid state at a temperature between the glass transition temperature and melting point of the polymer while feeding a continuous flow of a sweep nitrogen for removal of any by-products from the reactor. The solid-state polymerization increases the molecular weight of the polyamide obtained by melt polycondensation. In an embodiment, the solid state polymerization of the furan-based polyamide is carried out at a temperature in the range of 140-250° C. or at a minimum temperature of as low as 140° C., 150° C., 160° C., 170° C., 180° C., 190° C., 200° C., 220° C., 210° C., 220, 230° C., or 240° C., and as high as 150° C., 160° C., 170° C., 180° C., 190° C., 200° C., 220° C., 210° C., 220, 230° C., 240° C., 250° C. or within any range defined between any pair of the foregoing values.

The weight average molecular weight of the furan-based polyamide after melt polycondensation and before solid state polymerization is in the range of 3-75 kDA, or at least 3 kDa, 4 kDa, 5 kDa, 6 kDa, 7 kDa, 9 kDa, 15 kDa, 20 kDa, 30 kDa, 35 kDa, 40 kDa, 45 kDa, 50 kDa, 55 kDa, 60 kDa, 65 kDa, 70 kDa, or 75 kDa and after solid state polymerization is in the range of 10-100 kDA, or at least 10 kDa, 15 kDa, 30 kDa, 40 kDa, 50 kDa, 60 kDa, 70 kDa, 80 kDa, 90 kDa, or 100 kDa. The weight average molecular weight of the furan-based polyamide can be determined by methods known in the art, for example by size exclusion chromatography.

The process of making FDCA-based polyamides as disclosed hereinabove uses lower temperatures and shorter reaction times along with a more potentially acceptable environmental reaction medium which comprises no aqueous solution nor any organic solvents. The polyamide compositions produced using the present process have high degree of polymerization along with low polydispersity and enhanced crystallizability. Although not to be bound by any theory, it is believed that the melt polycondensation done at lower temperatures and in the absence of aqueous reaction media suppresses the side reactions of the propagating chain ends in the precipitated phase and thus reduces the apparent termination reactions.

The solvent-free melt-polycondensation process as described hereinabove produces furan-based polyamides that are suitable for manufacturing a variety of articles, including the following:
mono- and bi-oriented mono- and multi-layer film, cast and blown;
mono- and bi-oriented mono- and multi-layer film, multi-layered with other polymers, cast and blown;
mono-, multi-layer blown articles (for example bottles);
mono-, multi-layer injection-molded articles;
cling or shrink films for use with foodstuffs;
thermoformed foodstuff packaging or containers from cast sheet, both mono- and multi-layered, as in containers for milk, yogurt, meats, beverages and the like;
coatings obtained using the extrusion-coating or powder-coating method on substrates comprising metals, not limited to such metals as stainless steel, carbon steel, and aluminum; such coatings may include binders and agents to control flow such as silica or alumina;
multilayer laminates made by extrusion coating, solvent or extrusion lamination with rigid or flexible backings such as for example paper, plastic, aluminum, or metallic films;
foamed or foamable beads for the production of pieces obtained by sintering;
foamed and semi-foamed products, including foamed blocks formed using pre-expanded articles; and
foamed sheets, thermoformed foam sheets, and containers obtained from them for use in foodstuff packaging.

Non-limiting examples of methods and compositions produced therefrom disclosed herein include:
1. A process comprising:
   a) forming a reaction mixture by mixing one or more diamines, a diester comprising an ester derivative of 2,5-furandicarboxylic acid with a C₂ to C₁₂ aliphatic diol or a polyol, and a catalyst, such that the diamine is present in an excess amount of at least 1 mol % with respect to the diester amount; and
   b) melt polycondensing the reaction mixture in the absence of a solvent at a temperature in the range of 60° C. to a maximum temperature of 250° C. under an inert atmosphere, while removing alkyl alcohol to form a furan-based polyamide,
   wherein the one or more diamines comprises an aliphatic diamine, an aromatic diamine, or an alkylaromatic diamine.
2. The process of embodiment 1, wherein the catalyst is selected from hypophosphorus acid, potassium hypophosphite, sodium hypophosphite monohydrate, phosphoric acid, 4-chlorobutyl dihydroxyzinc, n-butyltin chloride dihydroxide, titanium(IV) isopropoxide, zinc acetate, 1-hydroxybenzotriazole, and sodium carbonate.
3. The process of embodiment 1 or 2, wherein the diamine is present in an excess amount of at least 5 mol % with respect to the diester amount.
4. The process of embodiment 1, 2, or 3, wherein the step of melt polycondensing the reaction mixture in the absence of a solvent at a temperature in the range of 60° C. to a maximum temperature of 250° C. under an inert atmosphere further comprises:
   i) first heating the reaction mixture to a temperature in the range of 60° C. to 100° C. for 30 to 60 minutes
   ii) ramping the temperature of the reaction mixture from 100° C. to a maximum temperature of 250° C. for an amount of time in the range of 30 to 240 minutes;
   iii) holding the maximum temperature of the reaction mixture constant for an amount of time in the range of 40 to 800 minutes.
5. The process of embodiment 1, 2, 3, or 4, further comprising adding at least one of a heat stabilizer or an anti-foaming agent to the reaction mixture.
6. The process of embodiment 1, 2, 3, 4, or 5, further comprising solid state polymerizing the furan-based polyamide at a temperature between the glass transition temperature and melting point of the polyamide.
7. The process of embodiment 1, 2, 3, 4, 5, or 6, further comprising solid state polymerizing the furan-based polyamide at a temperature in the range of 140° C. to 250° C.
8. The process of embodiment 1, 2, 3, 4, 5, 6, or 7 wherein the aliphatic diamine comprises one or more of hexamethylenediamine, 1,4-diaminobutane, 1,5-diaminopentane, (6-aminohexyl)carbamic acid, 1,2-diaminoethane, 1,12-diaminododecane, 1,3-diaminopropane, 1,5-diamino-2-methylpentane, 1,3-bis(aminomethyl)cyclohexane, 1,4-bis(aminomethyl)cyclohexane, mixtures of 1,3- and 1,4-bis(aminomethyl)cyclohexane, norbornanediamine, (2,5 (2,6) bis(aminomethyl)bicycle(2,2,1)heptane), 1,2-diaminocyclohexane, 1,4- or 1,3-diaminocyclohexane, isophoronediamine, and isomeric mixtures of bis(4-aminocyclohexyl)methane.
9. The process of embodiment 1, 2, 3, 4, 5, 6, 7, or 8 wherein the aromatic diamine comprises one or more of 1,3-diaminobenzene, phenylenediamine, 4,4′-diaminodiphenyl ether, 4,4′-diaminodiphenyl sulfone, 1,5-diaminonaphthalene, sulfonic-p-phenylene-diamine, 2,6-diamonopyridine, naphthidine, benzidine, and o-tolidine.
10. The process of embodiment 1, 2, 3, 4, 5, 6, 7, 8, or 9 wherein the alkylaromatic diamine comprises one or more of m-xylylene diamine, 1,3-bis(aminomethyl)benzene, p-xylylene diamine, and 2,5-bis-aminoethyl-p-xylene.
11. The process of embodiment 1, 2, 3, 4, 5, 6, or 7 wherein at least one of the one or more diamines is hexamethylenediamine.
12. The process of claim 1, 2, 3, 4, 5, 6, or 7 wherein at least one of the one or more diamines is trimethylenediamine.
13. The process of claim 1, 2, 3, 4, 5, 6, or 7 wherein at least one of the one or more diamines is m-xylylene diamine.
14. The process of claim 1, 2, 3, 4, 5, 6, 7, 8, 9, 10, 11, 12, or 13, wherein the furan-based polyamide comprises the following repeat unit:

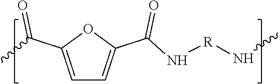

wherein R is selected from an alkyl, aromatic, and alkylaromatic group.

As used herein, the phrase “one or more” is intended to cover a non-exclusive inclusion. For example, one or more of A, B, and C implies any one of the following: A alone, B alone, C alone, a combination of A and B, a combination of B and C, a combination of A and C, or a combination of A, B, and C.

Unless otherwise defined, all technical and scientific terms used herein have the same meaning as commonly understood by one of ordinary skill in the art to which this disclosure belongs. Although methods and materials similar or equivalent to those described herein can be used in the practice or testing of embodiments of the disclosed compositions, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

In the foregoing specification, the concepts have been disclosed with reference to specific embodiments. However, one of ordinary skill in the art appreciates that various modifications and changes can be made without departing from the scope of the present disclosure as set forth in the claims below.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all embodiments.

It is to be appreciated that certain features are, for clarity, described herein in the context of separate embodiments, may also be provided in combination in a single embodiment. Conversely, various features that are, for brevity, described in the context of a single embodiment, may also be provided separately or in any sub combination. Further, reference to values stated in ranges include each and every value within that range.

The concepts disclosed herein will be further described in the following examples, which do not limit the scope of the disclosure described in the claims.

The examples cited here relate to furan-based polyamides. The discussion below describes how compositions comprising furan-based polyamides and articles made therefrom are formed.

### EXAMPLES

### Test Methods

### Weight-Average Molecular Weight by Size Exclusion Chromatographv

A size exclusion chromatography system, Alliance 2695™ (Waters Corporation, Milford, Mass.), was provided with a Waters 414™ differential refractive index detector, a multi-angle light scattering photometer DAWN Heleos II (Wyatt Technologies, Santa Barbara, Calif.), and a ViscoStar™ differential capillary viscometer detector (Wyatt). The software for data acquisition and reduction was Astra® version 6.1 by Wyatt. The columns used were two Shodex GPC HFIP-806M™ styrene-divinyl benzene columns with an exclusion limit of 2×10⁷ and 8,000/30 cm theoretical plates; and one Shodex GPC HFIP-804M™ styrene-divinyl benzene column with an exclusion limit 2×10⁵ and 10,000/30 cm theoretical plates.

The specimen was dissolved in 1,1,1,3,3,3-hexafluoro-2-propanol (HFIP) containing 0.01 M sodium trifluoroacetate by mixing at 50° C. with moderate agitation for four hours followed by filtration through a 0.45 μm PTFE filter. Concentration of the solution was circa 2 mg/mL.

Data was taken with the chromatograph set at 35° C., with a flow rate of 0.5 ml/min. The injection volume was 100 μl. The run time was 80 min. Data reduction was performed incorporating data from all three detectors described above. Eight scattering angles were employed with the light scattering detector. No standard for column calibration was involved in the data processing.

### Thermal Analysis

The polymer glass transition temperatures were measured by differential scanning calorimetry (DSC) with a DSC Q1000 TA Instrument under N₂ atmosphere with the first heating from room temperature to 300° C. at 10° C./min, followed by cooling to 0° C., and heating again (second heating) from 0 to 300° C. at 10° C./min. The reported glass transition temperature (Tg) was recorded during the second heating cycle.

### ¹H-NMR Spectroscopy

Polymer compositions were analyzed by proton nuclear magnetic resonance spectroscopy (¹H NMR) using standard methods known in the art. ¹H-NMR spectra were recorded on a 500 MHz NMR instrument in deuterated hexafluoroisopropanol (HFIP-d₂) or deuterated dimethylsulfoxide (DMSO-d₆). Proton chemical shifts are reported in ppm downfield of TMS using the resonance of the deuterated solvent as internal standard.

### Materials

As described in the examples below, Dimethyl furan-dicarboxylate (FDME) (99+% purity) was obtained from Sarchem. 1,6-Diaminohexane (HMD) (99%) and hypophosphorous acid (50%) were procured from Sigma-Aldrich. Carbowax® 8000, a defoaming agent was procured from DOW Chemicals. Irganox® 1098, a heat stabilizer, was procured from BASF. All chemicals were used as received unless otherwise specified.

### Example 1: Preparation of Furan-Based Polyamide (6F) from FDME and 10 mol % of excess HMD by solvent-free melt polycondensation

Step 1A: Preparation of Furan-Based Polyamide from FDME and HMD by Solvent-Free Melt Polycondensation

2,5-furandimethylester (FDME) (15 g), 1,6-diaminohexane (HMD) (10.4 g), hypophosphorous acid (0.0051 g), optional Carbowax 8000 and optional Irganox 1098 were charged to a 200 mL reactor equipped with overhead stirrer motor with a stainless steel blade and shaft and distillation head with receiver flask. The amounts of various reactants used are summarized in Table 1. The reactor was evacuated then filled with nitrogen three times with slow stirring. The reactants were heated initially from a temperature of 60-100° C. under nitrogen for a desired period of time (typically ˜30-60 minutes) with stirring to remove methanol; the specific temperature profile used is described in Table 2.

After a certain amount of time, nitrogen sweep was discontinued and a vacuum ramp was initiated over a desired period of time (˜10 minutes) to remove residual methanol while slowly increasing oil bath temperature. Vacuum was broken and nitrogen sweep was re-applied. Under nitrogen, oil bath temperature was further slowly increased to a desired setting (typically 180-210° C.). N₂ sweep was again discontinued and vacuum was then slowly applied over a desired period of time (˜14 minutes) to prevent foaming. Full vacuum was then used for the duration of the synthesis. Final hold temperature was 210° C. for 290 min. At end of hold time, vacuum was released and nitrogen was applied, followed by turning off stirring and heating and the reactor was slowly cooled over a ˜16 hour period.

The resulting polyamide product was recovered using liquid nitrogen to solidify and the product was chipped out. The product appeared as an orangish, translucent brittle solid. It was frozen in liquid nitrogen and ground using a IKA A10 S2 coffee grinder type mill.

Solubility of the polyamide was checked in methanol and dimethyl sulfoxide (DMSO). When heated, the polyamide appeared to be soluble in DMSO and insoluble in methanol (solution appeared cloudy/hazy with fine solids eventually settling on sides and bottom).

¹H-NMR (DMSO-d₆) δ: 8.42 (NH, s, 2H), 7.09 (s, 2H), 3.47-3.06 (m, 4H), 1.66-1.42 (m, 4H), 1.41-1.21 (m, 4H).

TABLE 1
Summary of Molar Feed Ratios

| | | | | Amount (g) | | |
|---|---|---|---|---|---|---|
| | | | Excess | Hypo- | Carbo- | Irganox |
| | Amount (g) | | Mole % | phosphorus | wax | 1098 |
| Example # | FDME | HMD | HMD | acid | 8000 | (g) |
| Example 1 | 15 | 10.4 | 10% | 0051 | 0 | 0 |
| Example 2.1 | 15 | 9.6 | 1.5% | 0.0112 | 0.018 | 0.0364 |
| Example 2.2 | 15 | 9.7 | 3 | 0.0113 | 0.0025 | 0.0162 |
| Example 2.3 | 14.9 | 9.97 | 5 | 0.0112 | 0.003 | 0.015 |
| Example 2.4 | 14.9 | 10.2 | 7 | 0.0103 | 0.0032 | 0.0305 |
| Example 2.5 | 15 | 10.4 | 10 | 0.028 | 0.0038 | 0.0116 |
| Example 2.6 | 14.9 | 11.0 | 15 | 0.0107 | 0.0037 | 0.0211 |
| Example 3.1 | 15 | 9.6 | 1.5 | 0.021 | 0.004 | 0.010 |
| Example 4 | 15 | 10.4 | 10 | 0051 | 0 | 0 |
| Example 5.1 | 15 | 9.6 | 1.5 | 0.0248 | 0.0056 | 0.0162 |
| Example 5.2 | 15 | 9.9 | 5 | 0.0267 | 0.0034 | 0.0154 |
| Example 5.3 | 15 | 10.4 | 10 | 0.012 | 0.0042 | 0.01 |

TABLE 2
Temperature Profiles of Melt Polycondensation

| | Example 1 | Example 2.1 |
|---|---|---|
| Temperature Ramp | 60° C./20 min, | 60° C./21 min, |
| | 80° C./33 min, | 80° C./29 min, |
| | 100° C./10 min, | 100° C./10 min, |
| | 110° C./13 min, | 100-115° C./6 min, |
| | 120° C./6 min, | 115-124° C./3 min, |
| | 130° C./14 min, | 124-137° C./5 min, |
| | 140° C./6 min, | 137-158° C./10 min, |
| | 150° C./8 min, | 158-170° C./6 min, |
| | 160° C./12 min, | 170-183/9 min, |
| | 170° C./7 min, | 183-193° C./5 min, |
| | 180° C./11 min, | 193-200° C./5 min, |
| | 190° C./18 min, | 200-210° C./15 min, |
| | 200° C./59 min, | 210-215° C./7 min, |
| Hold Temperature | 210° C./290 min | 215° C./357 min |

### Step 1B: Purification of Polyamide

The ground polyamide obtained according to Step 1A was split into two portions (˜8-9 grams each) and purified by two different methods.

Method 1:

Using a 500 mL single neck round bottom flask with magnetic stir bar, the 6F polyamide product (8.8 g) was added to the flask containing 250 mL methanol. A condenser was attached and under nitrogen, methanol was heated with stirring for ˜4 hours to reflux using an oil bath at about 70-80° C. After about 4 hours, the solution was stirred and cooled overnight followed by separating the solid from liquid by decantation. The solid obtained was dried for some time, broken up and transferred to an Erlenmeyer flask (1 L). 1000 mL of fresh methanol was added and the solution was stirred for about 12-18 h at room temperature with a magnetic stir bar. Fine solids were filtered using a 25 micron polyethylene type filter under house vacuum. Solids were washed 3 times with methanol, briefly suction dried, and then dried under high vacuum for 12-18 h. The resulting product was a powdery light tan weighing 5 g.

Method 2:

Using a 250 mL single neck round bottom flask with magnetic stir bar, the second portion of the 6F polyamide product was added to the flask containing 15 g of DMSO. After stirring for 1 h at room temperature, a condenser was attached and under nitrogen, DMSO was heated in an oil bath, first at 60° C. and then to 70° C. with stirring for about 5-6 h. An additional 105 g DMSO was added in increments to allow the dissolution of the material with only few particulates remaining. The solution was cooled overnight and the solids were separated by decantation into a 25 micron polyethylene type filter under house vacuum.

Two Erlenmeyer flasks (1 L each) containing 1000 mL of deionized (DI) water and 1 gram of MgSO₄ with magnetic stir bars were set up side by side. Filtered DMSO solution was split into two portions of 47 g each. Each portion was then slowly added to each flask using a plastic pipette over a ˜40-50 min period with stirring. The product precipitated and the solids were filtered separately from each flask using a 25 micron polyethylene type filter under house vacuum. Solids were washed 3 times with DI water and briefly suction dried. Solids from one Erlenmeyer were then high vacuum dried for 12-18 hrs. Product was a crusty light tan weighing 5 grams.

Solids from the second Erlenmeyer were further purified by adding them to an Erlenmeyer flask (1 L) containing 1000 mL of methanol. This solution was stirred for about 12-18 h at room temperature with a magnetic stir bar. Solids were filtered using a 25 micron polyethylene type filter under house vacuum. Solids were washed 3 times with methanol, briefly suction dried, and then high vacuum dried for 12-18 h. Product was a powdery light tan weighing 5 g. It should be mentioned that the second purification becomes unnecessary if a more dilute DMSO solution is used from the beginning.

Step 1C: Solid State Polymerization of the Purified Polyamide Obtained from FDME and HMD

A small amount (usually <1 gram) of the purified polyamide powder obtained from Step 1B was spread out over a ˜2″×2″ area of Teflon coated aluminum sheets. The material was placed in a VWR 1430M vacuum oven pre-heated to 180° C. and under vacuum and slight N₂ sweep. It was solid state polymerized (SSP) for a designated time (24 h and 60 h). Table 3 summarizes the molecular weight before and after SSP.

TABLE 3
Molecular Weight of Polyamides as Determined by SEC Analysis

| | | Melt polycondensation | | | | |
|---|---|---|---|---|---|---|
| | | before SSP | | | | After |
| | | | Time at | | SSP | SSP |
| | Excess | Max. | Max. | M_{w} | Time at | M_{w} |
| | HMD | Temp. | Temp. | (kDa), | 180° C. | (kDa) |
| Sample | (mol %) | (° C.) | (h) | (PDI) | (h) | (PDI) |
| Example 1 | 10 | 210 | 4.7 | 13.8 | 24 | 14.95 |
| | | | | (1.7) | | (2.6) |
| | | | | | 60 | 91.1 |
| | | | | | | (3.1) |

As shown in Table 3, the molecular weight of the sample prepared with 10 mol % excess HMD increased from 14.95 KDa to 91.1 kDa by increasing the time for solid state polymerization (SSP) from 24 hours to 60 hours, respectively. There was also an increase in polydispersity (PDI) from 2.6 to 3.1.

### Example 2.1-2.6: Effect of Excess HMD on the Properties of 6F Polyamides Prepared by Solvent-Free Melt Polycondensation of FDME and HMD

Step 2A: Preparation of 6F Polyamide from FDME and HMD by Solvent-Free Melt Polycondensation

A furan-based polyamide was synthesized from FDME and 1,6-diaminohexane (HMD) using procedure described in Example 1, except that the monomer feed amounts of HMD were changed, as given in Table 1, and also the temperature profile summarized in Table 2 was different from that of Example 1. The maximum melt polymerization temperature reached was 215° C. and the time at maximum temperature were different from those of Example 1. The polyamide obtained from FDME and HMD was designated as 6F polyamide.

### Step 2B: Purification of the 6F Polyamides Obtained in Step 2A

The 6F polyamides obtained in Step 2A were ground and purified using method 1 as described in Step 1B. After purification, the weight average molecular weight of the polymer was determined by size exclusion chromatography (SEC). The molecular weight and polydispersity index (PDI) results are provided in Table 4.

TABLE 4
Molecular Weight of 6F Polyamide as
a Function of Amount of Excess HMD

| | Excess HMD | Mₙ | M_{w} | |
|---|---|---|---|---|
| Sample | (mol %) | (kDa) | (kDa) | PDI |
| Example 2.1 | 1.5 | 4.5 | 7.6 | 1.7 |
| Example 2.2 | 3 | 4.51 | 7.19 | 1.6 |
| Example 2.3 | 5 | 11.62 | 20.09 | 1.7 |
| Example 2.4 | 7 | 8.14 | 14.63 | 1.8 |
| Example 2.5 | 10 | 7.13 | 13.78 | 1.9 |
| Example 2.6 | 15 | 6.7 | 11.42 | 1.7 |

From Table 4, it can be concluded that upon increasing the amount of excess HMD from 1.5 mol % to 15 mol %, the average molecular weight Mₙ and M_{w} of 6F polyamide showed a maximum at 5 mol % HMD excess. Polydispersity of 6F remained less than 2 for all these 6F polyamide samples. This surprising result, that an excess amount of HMD led to higher molecular weight polymer, is in contrast to what one would expect from theory. Although not to be bound by any theory, it is believed that:
The excess HMD added initially could compensate for the evaporated loss of HMD or water (of hydration).
The excess HMD could prevent some side reactions from occurring, such as cyclization and decarboxylation.
HMD could function as a reaction medium besides being a monomer, at least in the first stage of the reaction.
   Step 2C: Increase in Molecular Weight by SSP of Polyamide 6F Synthesized with 5 and 7 Mol % Excess HMD

6F polyamides of Examples 2.3 and 2.4 with 5 and 7 mol % excess HMD respectively, obtained above in Step 2B, were solid state polymerized using procedure as described in Step 1C of Example 1 at 180° C. for 24 hours. The results are summarized in Table 5.

TABLE 5
Effect of SSP on the molecular weight

| | | SSP reaction | | | | |
|---|---|---|---|---|---|---|
| | | time at a | | | | |
| | Excess | temperature | | | | |
| | HMD | of 180° C. | Mₙ | M_{w} | | IV |
| Sample | (mol %) | (hour) | (kDa) | (kDa) | PDI | (mL/g) |
| Example | 5 | 0 | 11.62 | 20.09 | 1.7 | — |
| 2.3 | | | | | | |
| Example | 5 | 24 | 12.85 | 38.83 | 3.0 | 82.5 |
| 2.3S | | | | | | |
| Example | 7 | 0 | 8.14 | 14.6 | 1.8 | 43.2 |
| 2.4 | | | | | | |
| Example | 7 | 24 | 9.45 | 22.89 | 2.4 | 58.4 |
| 2.4S | | | | | | |

Comparing molecular weight of 6F polyamide before and after SSP at 180° C. for 24 h, i.e. Example 2.3 with Example 2.3S and Example 2.4 with Example 2.4S, it should be noted that 6F polyamide with 5 mol % excess HMD showed a 93% increase in M_{w} whereas the polyamide with 7 mol % excess HMD showed a 57% increase in M_{w}. Hence, one can conclude from these experiments that the use of 5 mol % excess HMD generated furan-based polyamide with the highest M_{w} from both melt polymerization and SSP

### Example 3.1-3.3: The Effect of Catalyst and Reaction Time on Molecular Weight of 6F Polyamide Obtained with 1.5 Mol % HMD Excess by Solvent-Free Melt Polycondensation

A furan-based polyamide was synthesized from FDME and 1.5 mol % excess 1,6-diaminohexane (HMD) using procedure described in Step 1A of Example 1, except that the hypophosphorous acid catalyst amount and the melt polymerization reaction time at the maximum temperature of 215° C. were changed, as given in Table 6. The weight average molecular weight (M_{w}) of the 6F polyamide as determined by size exclusion chromatography (SEC) and polydispersity index (PDI) are provided in Table 6.

TABLE 6
Effect of Catalyst and Reaction Time
on Molecular Weight of 6F Polyamide

| | | Melt | | | |
|---|---|---|---|---|---|
| | | polymerization | | | |
| | | reaction time at | | | |
| | Hypophosphorous | the maximum | | | |
| | acid catalyst | temperature of | Mₙ | M_{w} | |
| Sample | amount (g) | 215° C. (hour) | (kDa) | (kDa) | PDI |
| Example 3.1 | 0.021 | 6.9 | 5.5 | 9.53 | 1.7 |
| Example 3.2 | 0.042 | 12.5 | 7.9 | 12.7 | 1.6 |
| Example 3.3 | 0.042 | 16.7 | 6.4 | 12.2 | 1.9 |

Comparing Example 3.1 with 3.2 in Table 5 shows that additional heating for 5.6 hours and doubling the amount of catalyst resulted in an increase in molecular weight M_{w} of the 6F polyamide from 9.53 KDa to 12.7 kDa. However, comparing Example 3.2 with 3.3 shows that additional heating for 4.2 hours resulted in a slight decrease in M_{w} from 7.9 kDa to 6.4 kDa and an increase in polydispersity from 1.6 to 1.9.

### Example 4: Increase in M_{w} of 6F Polyamide Synthesized with 10 mol % Excess HMD by SSP

Example 2.5 was repeated to generate a new batch of 6F polyamide with 10 mol % excess HMD using procedure as described in Step 1A of Example 1 and the as-obtained 6F polyamide was purified using method 1 described in Step 1B of Example 1. Solid-state polymerization (SSP) of the purified 6F polyamide was carried out using the procedure described in Step 1C of Example 1. The molecular weight results from SEC analysis are shown in Table 7.

TABLE 7
Molecular Weight Results

| | | Mₙ | M_{w} | |
|---|---|---|---|---|
| Sample | Description | (kDa) | (kDa) | PDI |
| Example 2.5 | Purified 6F obtained by melt | 7.13 | 13.78 | 1.9 |
| | polymerization | | | |
| Example 4 | Purified 6F obtained by melt | 8.1 | 13.8 | 1.7 |
| (repeat of | polycondensation | | | |
| Example 2.5) | | | | |
| Example 4S | 6F after SSP, 180° C., 60 h | 29.1 | 91.1 | 3.1 |

Comparing results for Example 2.45 with those for Example 4 in Table 7 shows that there is some variation in molecular weight from batch to batch. Furthermore, comparing Example 4 (before SSP) with Example 4S (after SSP at 180° C. for 60 h) shows a large increase (7 times) in M_{w} with an increase in PDI. This significant change in M_{w} and PDI is due to the presence of a large number of NH₂ chain ends available for chain extension. The results also showed that the increase in M_{w} by SSP can be controlled by time and temperature.

### Example 5.1-5.3: Preparation of Furan-Based Polyamide (6F) from FDME and 1.5, 5, 10 Mol % of Excess HMD by Solvent-Free Melt Polycondensation

Examples 2.1, 2.3, and 2.5 were repeated to generate new batches of 6F polyamides with 1.5, 5, and 10 mol % excess HMD using procedure as described in Step 1A of Example 1 except that the maximum temperature and the reaction time at the maximum temperature were different. The as-obtained 6F polyamides were purified using method 1 described in Step 1B of Example 1. Thermal analysis of the purified 6F polyamide was carried out and the results from DSC analysis are summarized in Table 8.

TABLE 8
DSC Analysis Results

| | | Melt poly- | | | | |
|---|---|---|---|---|---|---|
| | | condensation | | | | |
| | | reaction | | | | |
| | | time at the | | | | |
| | | maximum | Tₘ | | Phase | T_{g} |
| | Excess | temperature | (° C.) | | Transition | (° C.) |
| | HMD | of 210° C. | First | ΔH | (° C.) on | Second |
| Sample | (mol %) | (hour) | Heat | (J/g) | Cooling | Heat |
| Example | 1.5 | 6.8 | 179 | 52 | 132 | 137 |
| 5.1 | | | | | | (no Tₘ) |
| Example | 5 | 6.0 | 187 | 39 | 127 | 130 |
| 5.2 | | | | | | (no Tₘ) |
| Example | 10 | 6.8 | 176 | 32 | 115 | 125 |
| 5.3 | | | | | | (no Tₘ) |

As shown in Table 8, the thermal transitions of 6F polyamides prepared with 1.5, 5, and 10 mol % excess of HMD are similar. All as-synthesized and purified 6F polyamides appear to have some crystallinity. Since crystallinity is lost after first heating, when cooled at 10° C./min, this indicates slow crystallization rates.

### Example 6: Preparation of Furan-Based Polyamide (MXDF) from FDME and 10 Mol % of Excess m-Xylylenediamine (MXD) by Solvent-Free Melt Polycondensation

A furan-based polyamide (MXDF) was synthesized from FDME and 10 mol % excess m-xylylenediamine (MXD) using procedure described in Step 1A of Example 1, using FDME (10 g), MXD (8.1 g), hypophosphorous acid catalyst (0.035), Carbowax (0.0007 g), and Irganox 1098 (0.0070 g). The melt polycondensation was carried out using the following temperature profile with the maximum temperature of 220° C. Temperature ramp profile was 60° C./14 min., 80° C./36 min., 100° C./15 min., 120° C./5 min., 130° C./7 min., 140° C./8 min., 150° C./15 min., ° C./25 min., 200° C./25 min., 210° C./42 min., and final hold temperature 220° C./280 min. The MXDF polyamide was a light yellow (cream) in color with a yield of 12 g.

The as-obtained MXDF polyamide was purified using the method 1 as described in Step 1B of Example 1. The purified MXDF polyamide showed a glass transition temperature T_{g} of 181° C. The weight average molecular weight (M_{w}) of the MXDF polyamide was determined by size exclusion chromatography (SEC). Molecular weights and polydispersity index (PDI) are provided in Table 10.

The purified MXDF was solid state polymerized using procedure as described in Step 1C of Example 1 at the SSP temperature of 210° C. for 12 and 24 hours. Results for the furan-based polyamide obtained after 12 hours of SSP (Example 6S) are shown in Table 10.

TABLE 10
Results for Example 6

| | | Mₙ | M_{w} | |
|---|---|---|---|---|
| Sample | Description | (kDa) | (kDa) | PDI |
| Example 6 | MXDF | 2.96 | 9.21 | 3.1 |
| Example 6S | MXDF SSP 12 h | 11.14 | 53.7 | 4.7 |

### Example 7: Preparation of Furan-Based Polyamide (3F) from FDME and 5 Mol % of Excess 1,3-Diamino Propane (DAP) by Solvent-Free Melt Polycondensation Using Hypophosphorous Acid as Catalyst

Step 7A: Preparation of Furan-Based Polyamide from FDME and DAP by Solvent-Free Melt Polycondensation

A furan-based polyamide (3F) was synthesized from FDME and 5 mol % excess 1,3-diamino propane (DAP) using procedure described in Step 1A of Example 1, using FDME (15 g), DAP (6.339 g), hypophosphorous acid catalyst (0.008 g), Carbowax (0.001 g) and Irganox 1098 (0.008 g). The melt polycondensation was carried out using the following temperature profile with the maximum temperature of 250° C.

Temperature ramp profile was 60° C./23 min., 80° C./32 min., 100° C./5 min., 120° C./8 min., 130° C./7 min., 140° C./7 min., 150° C./7 min., 180° C./14 min., 200° C./16 min., 210° C./13 min., 220° C./12 min., 230° C./34 min., 250° C./16 min., and final hold temperature 250° C./329 min. The 3F polyamide was yellow to orange in color, translucent and brittle.

Step 7B: Purification of the 3F Polyamide Obtained in Step 7A

The polyamide obtained in Step 7A was found to have some solubility in methanol, and hence two different purification methods were used. The as-obtained 3F polyamide was purified using primarily method 2 as dissolving the material and then precipitating appeared to better remove impurities.

### Method 1:

Using a 500 mL single-neck round-bottom flask with magnetic stir bar, the 3F polyamide product (typically 8-16 grams) was added to the flask containing 250 mL acetone. The solution was stirred for about 12-18 hours at room temperature. Liquid was decanted after solids settled to the bottom of the flask and additional acetone was added. Solids were broken up with a spatula. A condenser was attached to the flask and under nitrogen acetone was heated with stirring for about 4-8 hours to reflux using an oil bath at about 70-80° C. Fine solids were filtered using a 25 micron polyethylene type filter under house vacuum. Solids were washed 3 times with acetone, briefly suction dried, and then dried under high vacuum for 12-18 h. The resulting product was a powdery light tan weighing typically 5-13 grams.

### Method 2:

Using a 50-100 mL single-neck round-bottom flask with magnetic stir bar, the 3F polyamide (5 grams) was dissolved in minimal amount (8 grams) of methanol. Heating in an oil bath was used if needed. Using a 1 L Erylenmeyer flask with magnetic stir bar or a stainless steel beaker with an IKA overhead motor and dispersion type stir blade, solution was slowly added drop wise with plastic pipette to 1000 mL acetone with rapid stirring. Precipitation did not work well if methanol solution was of a greater viscosity than honey (globules and not a fine precipitate were made). Solution had to be just slightly more fluid than honey. Fine solids were filtered using a 25 micron polyethylene type filter under house vacuum. Solids were washed 3 times with acetone, briefly suction dried, and then dried under high vacuum for 12-18 h. The resulting product was a powdery light tan weighing typically 4 grams.

The purified 3F polyamide showed a glass transition temperature T_{g} of 136.24° C. The weight average molecular weight (M_{w}) of the 3F polyamide was determined by size exclusion chromatography (SEC). Molecular weights and polydispersity index (PDI) are provided in Table 11.

### Example 8: Preparation of Furan-Based Polyamide (3F) from FDME and 5 Mol % of Excess 1,3-Diamino Propane (DAP) by Solvent-Free Melt Polycondensation Using 1-Hydroxybenzotriazole Hydrate as a Catalyst

A furan-based polyamide (3F) was synthesized from FDME and 5 mol % excess 1,3-diamino propane (DAP) using procedure described in Step 1A of Example 1, using FDME (15 g), DAP (6.4 g), 1-hydroxybenzotriazole hydrate catalyst (0.014 g), Carbowax (0.024 g), and Irganox 1098 (0.016 g). The melt polycondensation was carried out using the following temperature profile with the maximum temperature of 250° C.

Temperature ramp profile was 60° C./23 min., 80° C./32 min., 100° C./5 min., 120° C./10 min., 130° C./5 min., 140° C./3 min., 150° C./4 min., 180° C./16 min., 200° C./12 min., 210° C./7 min., 220° C./28 min., 250° C./10 min., and final hold temperature 250° C./345 min. The 3F polyamide was yellow to orange in color, translucent and brittle. ¹H-NMR (HFiP-d₂) δ: 7.22 (s, 2H), 3.64-3.47 (m, 4H), 2.09-1.88 (m, 2H)

The as-obtained 3F polyamide was purified using method 2, as described above in step 7A of Example 7.

The weight average molecular weight (M_{w}) of the 3F polyamide was determined by size exclusion chromatography (SEC). Molecular weight and polydispersity index are provided in Table 11.

The purified 3F was solid state polymerized using procedure as described in Step 1C of Example 1 at the SSP temperature of 180° C. for 24, 48, 72, 96, and 156 hours.

TABLE 11
Results for Examples 7 and 8

| | | Mₙ | M_{w} | |
|---|---|---|---|---|
| Sample | Description | (kDa) | (kDa) | PDI |
| Example 7 | Purified 3F, HPA catalyst | 4.78 | 20.95 | 4.4 |
| Example 8 | Purified 3F, HBT catalyst | 4.45 | 15.38 | 3.5 |
| Example | 3F after SSP at 180° C. for 24 h | 6.66 | 15.81 | 2.4 |
| 8S.1 | | | | |
| Example | 3F after SSP at 180° C. for 48 h | 7.46 | 17.23 | 2.3 |
| 8S.2 | | | | |
| Example | 3F after SSP at 180° C. for 72 h | 6.97 | 16.47 | 2.4 |
| 8S.3 | | | | |
| Example | 3F after SSP at 180° C. for 96 h | 7.73 | 18.48 | 2.4 |
| 8S.4 | | | | |
| Example | 3F after SSP at 180° C. for 156 h | 7.97 | 19.26 | 2.4 |
| 8S.5 | | | | |

Table 11 shows that 3F polyamide showed a steady increase in molecular weight with polydispersity remaining almost constant as the 3F was solid state polymerized for longer time.

### Example 9: Preparation of Furan-Based Copolyamide (3F/MXDF) from FDME, 2.5 Mol % of Excess 1,3-Diamino Propane (DAP) and 2.5 Mol % of Excess m-Xylylenediamine (MXD) by Solvent-Free Melt Polycondensation

A furan-based copolyamide (3F/MXDF) was synthesized from FDME, 2.5 mol % excess 1,3-diamino propane (DAP) and 2.5 mol % of excess m-xylylenediamine (MXD) using procedure described in Step 1A of Example 1, using FDME (15 g), DAP (3.094 g), m-xylylenediamine (MXD) (5.685 g), hypophosphorous acid catalyst (0.009 g), Carbowax (0.001 g), and Irganox 1098 (0.009 g). The melt polycondensation was carried out using the following temperature profile with the maximum temperature of 250° C.

Temperature ramp profile was 60° C./25 min., 80° C./25 min., 100° C./17 min., 110° C./7 min., 120° C./6 min., 130° C./5 min., 140° C./10 min., 150° C./12 min., 160° C./19 min., 200° C./31 min., 220° C./21 min., 235° C./24 min., and final hold temperature 250° C./218 min. The 3F/MXDF copolyamide was yellow to orange in color, translucent and brittle.

The as-obtained 3F/MXDF copolyamide was purified using method 1 as described in Step 1B of Example 1, except that methanol was replaced by acetone as the solvent.

After purification, the weight average molecular weight (M_{w}) of the 3F/MXDF copolyamide was determined by Size exclusion chromatography (SEC) and polydispersity and the results are provided in Table 12.

TABLE 12
Results for Example 9

| | | Mₙ | M_{w} | |
|---|---|---|---|---|
| Sample | Description | (kDa) | (kDa) | PDI |
| Example 9 | 3F/MXDF | 1.95 | 6.59 | 3.4 |

What is claimed is:

1. A process comprising:
a) forming a reaction mixture by mixing one or more diamines, a diester comprising an ester derivative of 2,5-furandicarboxylic acid with a C₂ to C₁₂ aliphatic diol or a polyol, and a catalyst, such that the diamine is present in an excess amount of at least 1 mol % with respect to the diester amount; and
b) melt polycondensing the reaction mixture in the absence of a solvent at a temperature in the range of 60° C. to a maximum temperature of 250° C. under an inert atmosphere, while removing alkyl alcohol to form a furan-based polyamide, wherein the one or more diamines comprises an aliphatic diamine, an aromatic diamine, or an alkylaromatic diamine.

2. The process of claim 1, wherein the catalyst is selected from hypophosphorus acid, potassium hypophosphite, sodium hypophosphite monohydrate, phosphoric acid, 4-chlorobutyl dihydroxyzinc, n-butyltin chloride dihydroxide, titanium(IV) isopropoxide, zinc acetate, 1-hydroxybenzotriazole, and sodium carbonate.

3. The process of claim 1, wherein the diamine is present in the reaction mixture in an excess amount of at least 5 mol % with respect to the diester amount.

4. The process of claim 1, wherein the step of melt polycondensing the reaction mixture in the absence of a solvent at a temperature in the range of 60° C. to a maximum temperature of 250° C. under an inert atmosphere further comprises:
i) first heating the reaction mixture to a temperature in the range of 60° C. to 100° C. for 30 to 60 minutes
ii) ramping the temperature of the reaction mixture from 100° C. to a maximum temperature of 250° C. for an amount of time in the range of 30 to 240 minutes;
iii) holding the maximum temperature of the reaction mixture constant for an amount of time in the range of 40 to 800 minutes.

5. The process of claim 1, further comprising adding at least one of a heat stabilizer or an anti-foaming agent to the reaction mixture.

6. The process of claim 1, further comprising solid state polymerizing the furan-based polyamide at a temperature between the glass transition temperature and melting point of the polyamide.

7. The process of claim 1, further comprising solid state polymerizing the furan-based polyamide at a temperature in the range of 140° C. to 250° C.

8. The process of claim 1, wherein the aliphatic diamine comprises one or more of 1,6-diaminohexane, 1,4-diaminobutane, 1,5-diaminopentane, (6-aminohexyl)carbamic acid, 1,2-diaminoethane, 1,12-diaminododecane, 1,3-diaminopropane, 1,5-diamino-2-methylpentane, 1,3-bis(aminomethyl)cyclohexane, 1,4-bis(aminomethyl)cyclohexane, mixtures of 1,3- and 1,4-bis(aminomethyl)cyclohexane, norbornanediamine, (2,5 (2,6) bis(aminomethyl)bicycle(2,2,1)heptane), 1,2-diaminocyclohexane, 1,4- or 1,3-diaminocyclohexane, isophoronediamine, and isomeric mixtures of bis(4-aminocyclohexyl)methane.

9. The process of claim 1, wherein the aromatic diamine comprises one or more of 1,3-diaminobenzene, phenylenediamine, 4,4′-diaminodiphenyl ether, 4,4′-diaminodiphenyl sulfone, 1,5-diaminonaphthalene, sulfonic-p-phenylene-diamine, 2,6-diamonopyridine, naphthidine, benzidine, and o-tolidine.

10. The process of claim 1, wherein the alkylaromatic diamine comprises one or more of m-xylylene diamine, 1,3-bis(aminomethyl)benzene, p-xylylene diamine, and 2,5-bis-aminoethyl-p-xylene.

11. The process of claim 1, wherein at least one of the one or more diamines is hexamethylenediamine.

12. The process of claim 1, wherein at least one of the one or more diamines is trimethylenediamine.

13. The process of claim 1, wherein at least one of the one or more diamines is m-xylylene diamine.

14. The process of claim 1, wherein the furan-based polyamide comprises the following repeat unit: 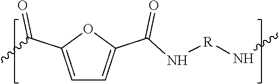
wherein R is selected from an alkyl, aromatic, and alkylaromatic group.
